(19) United States
(12) Patent Application Publication
(10) Pub. No.: US 2002/0162228 A1
(43) Pub. Date: Nov. 7, 2002

(54) Paper cutter

(76) Inventor: Hsiu Chen Lee, Touliu City (TW)

Correspondence Address: BACON & THOMAS, PLLC, 4th Floor, 625 Slaters Lane, Alexandria, VA, 22314-1176, US

(21) Appl. No.: 09/848,321

(22) Filed: May 4, 2001

(51) Int. Cl. B26B 3/00; B26B 29/00

(52) U.S. Cl. 30/310; 30/293; 30/286

(57) ABSTRACT

A paper cutter with a mold board has a base, an adjusting seat, a knife mount, a cutting knife, a bias spring, an adjusting nut, a positioning knob and a holding member. The cutting knife is secured to the knife mount pivotally secured to the adjusting seat. The bias spring is placed in a hole on the adjusting seat and housed in a cavity on the knife mount and retained by the adjusting nut in contact with the knife mount, permitting the cutting knife to be flexibly operated. The adjusting seat is secured to a guide groove of the base. The mold board has plural guide tracks on one side and anti-slip stickers on the other side. The base is slidably mounted to the mold board to make the cutting knife operate with ease, precision and stability.

### BACKGROUND OF THE INVENTION

The present invention relates to a paper cutter in combination with a mold board. The paper cutter is made up of a base, an adjusting seat, a knife mount, a pivot shaft, a cutting knife, a bias spring, an adjusting nut, a positioning knob, a locking screw and a holding member. The cutting knife is secured to the rear end of the knife mount which is pivotally secured by the pivot shaft to a receiving space under the adjusting seat. The bias spring is placed in a screw hole on the adjusting seat and housed in a cylindrical cavity on the knife mount and locked in place by the adjusting nut whose bottom is in urging contact with the top of the knife mount so as to permit the cutting knife to be flexibly operated. The rear portion of the adjusting seat is adjustably secured in position to a guide groove of the base by a positioning knob in combination with a locking screw. The mold board has a plurality of equally distanced guide tracks on the inner and outer sides thereof with a positioning groove defined between every two guide tracks. The bottom of the mold board is provided with anti-slip stickers. The base is slidably mounted onto the mold board so as to make the cutting knife cut paper with ease and stability along a linear or curved line.

In general, people cut paper with various kinds of cutting knife. To cut paper in a linear form, a straight ruler is used in combination with a cutting knife. The ruler is pressed with pressure against a piece of paper and the cutting knife is guided along the edge of the ruler. It is often found that the cutting can be easily guided astray. In case paper is to be cut in a curved line, the cutting work becomes difficult and tedious. The result of the cutting on paper is not smooth and satisfactory at all.

### SUMMARY OF THE INVENTION

Therefore, the primary object of the present invention is to provide a paper cutter which has a base slidably mounted to a linear or curved mold board having a plurality of positioning grooves defined between every two guide tracks by way of the front and rear positioning projections disposed on the underside of the base whereby the paper cutter can be smoothly and steadily operated to cut paper in a linear or curved line.

Another object of the present invention is to provide a paper cutter wherein the base is provided with a pair of wing extensions which permits the base to be in pressing contact with the mold board, making the cutting of paper in a stable and precise manner.

One further object of the present invention is to provide a paper cutter which operates in combination with a mold board having anti-slip stickers attached to the underside thereof so as to increase frictional force between the mold board and paper, preventing the mold board from slipping in paper cutting operations.

One still further object of the present invention is to provide a paper cutter which has a knife mount flexibly engaged with an adjusting seat by way of a bias spring and an adjusting nut whereby the distance between the cutting knife and pieces of paper to be cut can be flexibly adjusted so as to enable the cutting knife to cut pieces of paper of various thickness and properties.

One still further object of the present invention is to provide a paper cutter having a knife mount which is secured to an adjusting seat. The adjusting seat is adjustably fixed to the adjusting seat and the base by way of a positioning knob, a locking screw and a holding member so as to permit the cutter to be operated in a convenient, dexterous and ready manner.

### BRIEF DESCRIPTION OF THE DRAWINGS

FIG. 1 is a perspective diagram showing the exploded components of the present invention;

FIG. 2 is a sectional diagram showing the assembly of the present invention;

FIG. 3 is a diagram showing the adjustment of the height of a cutting knife;

FIG. 4 is a diagram showing the adjustment of the integral length of the cutter of the present invention;

FIG. 5 is a diagram showing the paper cutter in operation with a mold board.

### DETAILED DESCRIPTION OF THE PREFERRED EMBODIMENT

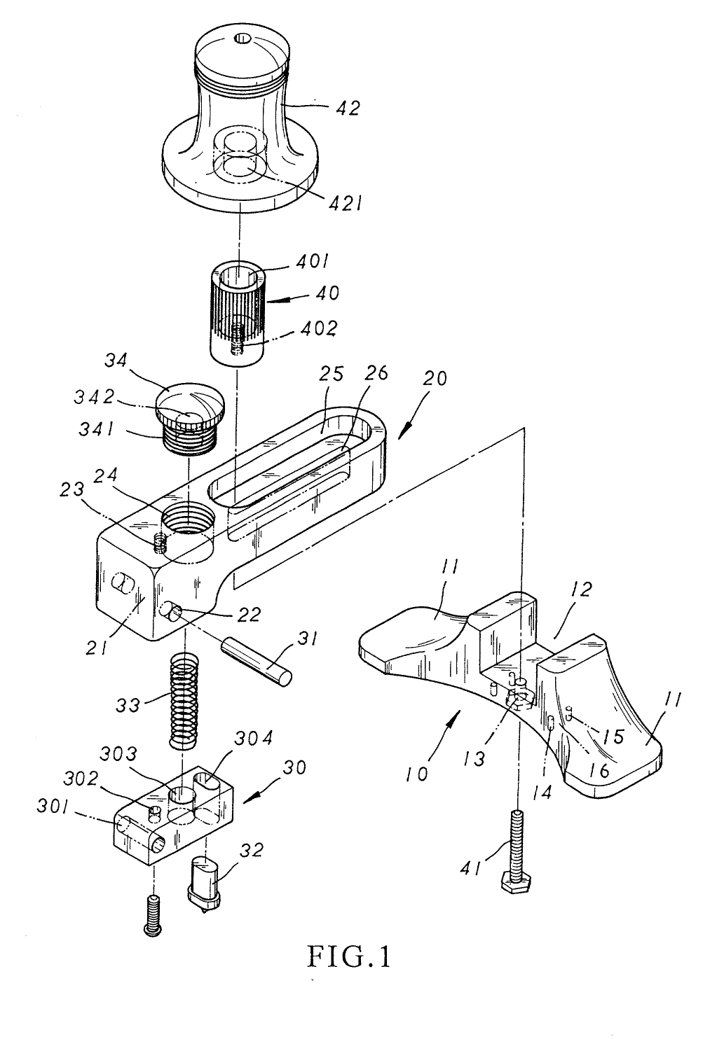

Referring to FIG. 1, the paper cutter is operated in combination with a linear and curved mold board 50. The paper cutter is made up of a base 10, an adjusting seat 20, a knife mount 30, a pivot shaft 3 1, a cutting knife 32, a bias spring 33, an adjusting nut 34, a positioning knob 40, a locking screw 41 and a holding member 42.

The base 10 has an extension wing 11 at each side and a guide groove 12 of a proper depth at the center thereof with which the adjusting seat 20 is slidably engaged. At the bottom of the guide groove 12 is disposed a screw hole 13. The underside of the base 10 are provided with a pair of front projections 14 and rear projections 15 with a retaining space 16 defined between each pair of a front and rear projections 14, 15. The size of the retaining space 16 is determined by the thickness of guide tracks 51 of the mold board 50.

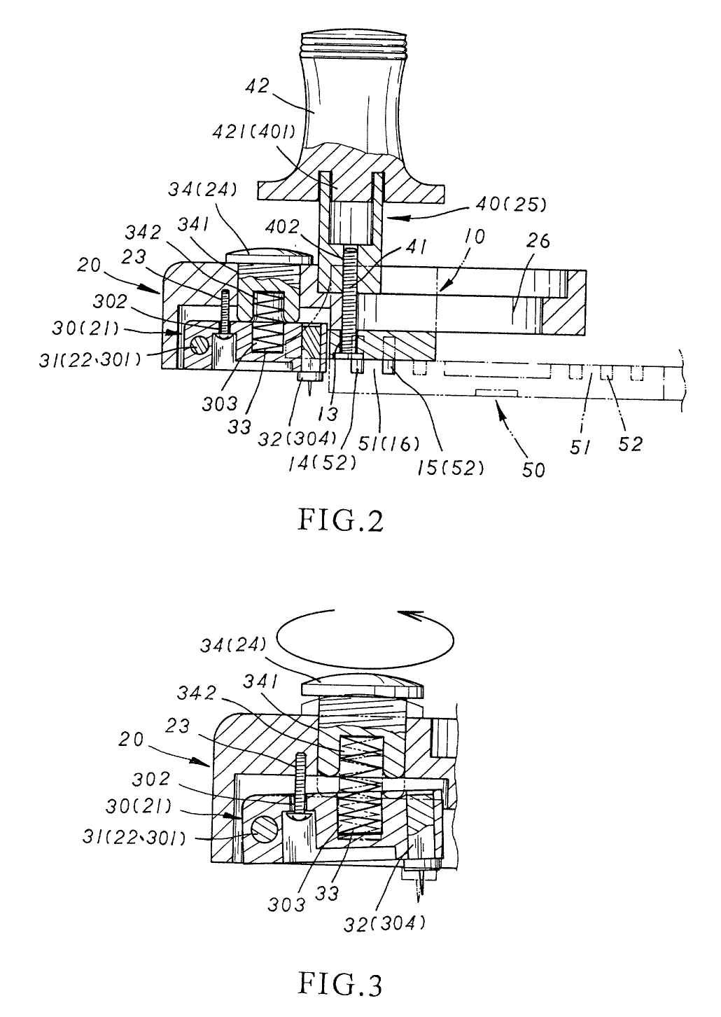

The adjusting seat 20 of an approximately rectangular shape has a receiving chamber 21 at one end thereof in which the knife mount 30 is housed, as shown in FIG. 2. On each side of the inner walls of the receiving chamber 21 is respectively disposed a through hole 22. A retaining hole 23 of a proper depth is disposed at the center of the receiving chamber 21. An internally threaded hole 24 is disposed at the rear position of the receiving chamber 21 for receiving an adjusting nut 34. An elongated slide groove 25 with which is engaged the positioning knob 40. A slot 26 is disposed at the bottom of the slide groove 25.

The knife mount 30 is provided with a horizontal shaft hole 301 at one end and a vertical locking hole 302 adjacent the center thereof. A receiving recess 303 is disposed on the top and adjacent the other end of the knife mount 30. A knife securing cavity 304 is positioned at the other end. The adjusting nut 34 is provided with slip-free grooves and has an externally threaded lower section 341 and a vertical cavity 342 at the central bottom thereof. The positioning knob 40 of a cylindrical form has an insertion cavity 401 at the top thereof A screw hole 402 is defined at the bottom of the positioning knob 40.

The holding member 42 is of a reverse T-shaped cross section, having a cavity at the bottom thereof which is slightly larger than the positioning knob 40. A retaining post 421 extends from the center of the cavity. The top surface of the mold board 50 is provided with a plurality of equally distanced tracks 51 with a retaining groove 52 formed between every two tracks 1. At the bottom of the mold board 50 is disposed an anti-slip sticker.

To assemble the paper cutter, as shown in FIG. 2, the cutting knife 32 is engaged with the knife securing cavity 304 of the knife mount 30 that is further positioned in the receiving chamber 21 of the adjusting seat 20 with the internally threaded hole 24 aligned with the receiving recess 303 of the knife mount 30. The pivot shaft 31 pivotally holding the knife mount 30 and the adjusting seat 20 together is led through the through holes 22 of the adjusting seat 20 and the horizontal shaft hole 301 of the knife mount 30. A screw is led through the vertical locking hole 302 of the knife mount and the retaining hole 23 of the adjusting seat 20 to loosely retain the knife mount 30, permitting the knife mount 30 to slightly operate in a pivotal manner up and down. The bias spring 33 placed in the internally threaded hole 24 of the adjusting seat 20 and further in the receiving recess 303 of the knife mount 30 is retained in place by the adjusting nut 34 having external threads 341 engaged with the internally threaded surface of the receiving recess 303 with the bottom surface of the adjusting nut 34 in abutment against the top surface of the knife mount 30 so as to properly compress the bias spring 33. Now, the adjusting nut 34 can be rotated in adjustment to vary the distance of the cutting knife 32 on the knife mount 30 and cut paper, as shown in FIG. 3. The elastic bias spring 33 permits the cutting knife 32 to be flexibly operated.

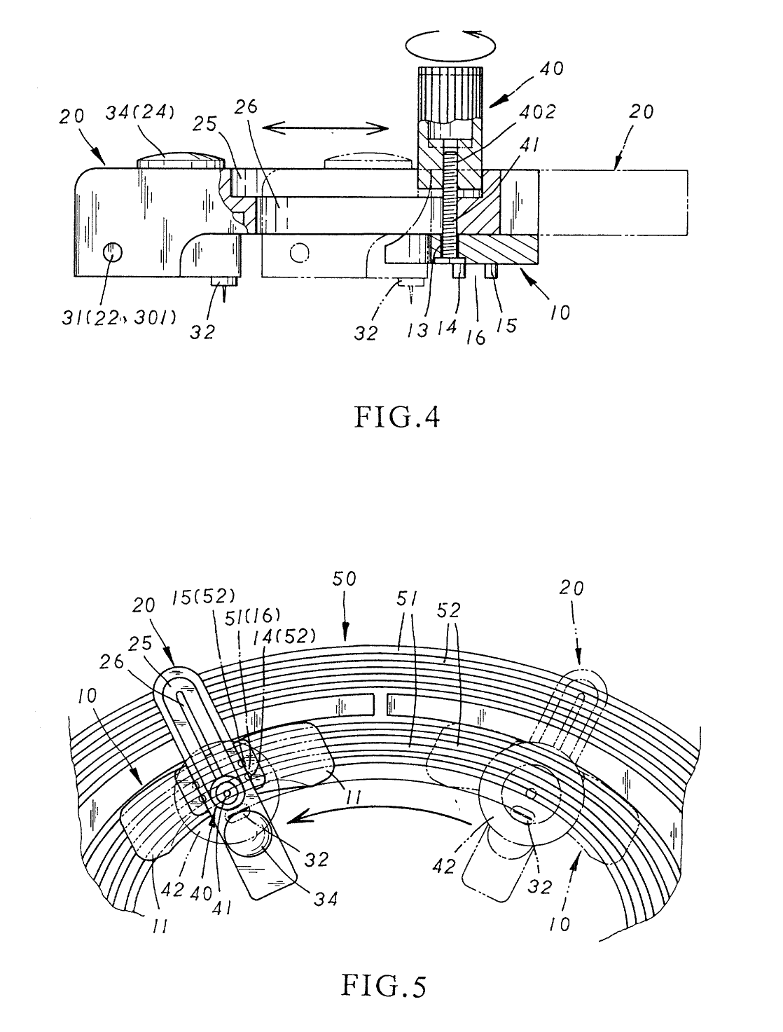

The adjusting seat 20 engaged with the knife mount 30 is placed astride of the guide groove 12 of the base 10. Then the lower section of the positioning knob 40 is engaged with the slide groove 25 of the adjusting seat 20; and the locking screw 41 is led through the screw hole 13 of the base 10 and the short slot 26 of the adjusting seat 20 to finally secure to the screw bole 402 of the positioning knob 40 in place. Thereby the adjusting seat 20 can be secured in place by the base 10, the positioning knob 40 and the locking screw 41 and can be adjustably positioned back and forth by actuation of the adjusting knob 40, the locking screw 41 in the slide groove 25 with respect to the base 10, as shown in FIG. 4.

At last, the holding member 42 is engaged with the positioning knob 40 by the retaining post 421 of the holding member 42, which is inserted into the insertion cavity 401 of the positioning knob 40 and is ratably operated.

Referring to FIGS. 2, 5, in practical operation, the base 10 of the paper cutter is engaged with the mold board 50 by means of the paired front and rear projections 14, 15 that are inserted in the retaining grooves 52 next to a guide track 51 of the mold board 50 respectively with the retaining space 16 between the paired front and rear projections 14, 15 firmly holding the guide track 51 in a balance manner at the right and left sides of the adjusting seat 20 which is mounted astride to the base 10. The extension wings 11 of the base 10 are located in engagement with the top of the guide tracks 51 of the mold board 50.

Then the adjusting nut 34 is rotated to adjustably vary the distance between the cutting knife 32 on the knife mount 30 and paper to be cut. Afterwards, the holding member 42 is removed and the positioning knob 40 is rotated and the locking screw 41 is relieved so that the cutting knife 32 of the knife mount 30 secured to the adjusting seat 20 can be adjusted back and forth along the elongated slide groove 25 on the base 10 to a desired position. Then the holding member 42 is re-engaged with the positioning knob 40, so the user can hold the holding member 42 to operate on the paper cutter.

As the mold board 50 is provided with anti-slip stickers on the underside thereof, the cut paper and the mold board 50 can be firmly engaged with each other. The friction between the base 10 and the mold board 50 is relatively less and the cut paper is positioned with pressure, the base 10 can be smoothly and readily moved along the mold board 50 to cut paper in parallel with the guide tracks 51 in linear or curved line.

In summary, the paper cutter has the following advantages:

1. The base 10 can firmly engaged with the mold board 50 by way of the front and rear projections 14, 1 5 engaged with the guide tracks, so the base 10 can be steadily moved to cut paper precisely along a linear or curved line without deviation.

2. The extension wings 11 of the base 10 are positioned astride of the mold board 50 to make the cutting operation in a stable and precise manner.

3. The anti-slip stickers on the underside of the mold board 50 increases the friction between a cut paper and the mold board 50 so as to make the base 10 move on the mold board with pressure in a smooth manner.

4. The adjusting nut 34 can be adjusted to vary the distance between cut paper and the cutting knife 32 on the knife mount 30 and the bias spring 33 permits the cutting knife 32 to be flexibly operated to be adapted for paper of various thickness.

5. The adjusting seat 20 can be easily adjusted to move back and forth on the guide groove 25 along the base 10 to precisely position the cutting knife on the mold board 50.

6. The cutting knife 32 on the knife mount 30 can be moved along a linear or curved line or in other various ways to cut paper simply by varying the forms of the guide tracks 51 of the mold board 50 and the cutting knife 32.

I claim:

1. A paper cutter operating in combination with a mold board, comprising:
a cutting knife;
a knife mount with which said cutting knife is removably engaged;
an adjusting seat to which said knife mount is secured in a slightly pivotal manner;
a bias spring housed in both said adjusting seat and said knife mount so as to permit said knife mount to be resiliently operable with respect to said adjusting seat;
a base with which said adjusting seat is adjustably engaged;
said adjusting seat being removably secured to said base;
a mold board to which said base is slidably mounted having a plurality of guide tracks;
a holding means removably mounted to said adjusting seat for guiding said adjusting seat mounted to said base which is slidable on said mold board along a line whereby said cutting knife can cut paper disposed under said base;
whereby said base in combination with said adjusting seat can be controlled by said holding means to slidably move on said mold board along said guide tracks, permitting said cutting knife to cut paper disposed under said mold board.

2. The paper cutter as claimed in claim 1 wherein said guide tracks on said mold board is disposed in a linear form.

3. The paper cutter as claimed in claim 1 wherein said guide tracks on said mold board is disposed in a curved form.

4. The paper cutter as claimed in claim 1 wherein said base has a pair of front and rear projections on an underside thereof and the distance between each paired front and rear projections are determined by the thickness of the guide tracks of said mold board.

5. The paper cutter as claimed in claim 1 wherein said base has an extension wing at each end and a guide groove at the center thereof so as to permit said adjusting seat to be adjusted in said guide groove; and said adjusting seat and said base are secured to each other by a screw engaged with said holding means.

6. The paper cutter as claimed in claim 1 wherein said adjusting seat has an elongated slide groove in which a slot is defined is longitudinally disposed on said adjusting seat so as to permit said adjusting seat and said base to be bound together by a screw led through said slot and engaged with said holding means.
